(19) United States
(12) Patent Application Publication
(10) Pub. No.: US 2004/0050408 A1
(43) Pub. Date: Mar. 18, 2004

(54) Treatment systems and methods

(76) Inventors: Kurt K. Christenson, Minnetonka, MN (US); Christina Rathman, Chaska, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/244,099

(22) Filed: Sep. 13, 2002

(51) Int. Cl. B08B 3/00

(52) U.S. Cl. 134/184; 134/186; 134/201

(57) ABSTRACT

Improved immersion vessel configurations for treatment of precision manufactured devices such as semiconductor wafers are provided. In one aspect, an immersion vessel is provided wherein the sidewalls of the immersion vessel are less than about 10 mm from the major surfaces of the wafer or wafers. In another aspect, an immersion vessel provided with a megasonic transducer has a cleaning zone that is progressively smaller in width from the area proximal to the transducer to the area that is distal from the transducer. In another aspect, an immersion vessel is provided having at least one movable sidewall to provide variable volume capacity of liquid in the vessel. In another aspect, a self-cleaning wafer liquid treatment system is provided having a plurality of cascade chambers.

### FIELD OF THE INVENTION

The present invention relates to the wet treatment of objects within a liquid bath. More specifically, the present invention relates to immersion vessel configurations providing superior efficiency and effectiveness of treatment processes for objects such as semiconductor wafers to be treated by precision manufacturing processes in a liquid bath.

### BACKGROUND OF THE PRESENT INVENTION

The present invention has been developed, in particular, for its application to objects that are treated with a solution, such as semiconductor wafers or similar substrates, whether raw, etched with any feature, coated, or integrated with conductor leads or traces as an integrated circuit device, lead frames, medical devices, disks and heads, flat panel displays, microelectronic masks, micromechanical devices, microoptical devices, and the like. These objects have become increasingly more and more difficult to treat because they are being manufactured in smaller and smaller sizes, and contain extremely small features to be generated and treated. Precision manufacturing techniques are required to properly generate such component parts. Thus, layers of various materials with low toleration for variance, and the generation of very small features at submicron size in the layers of such objects, are created by chemical treatment and etching processes. Uniformity of layers and precise quantities of treatments are required to provide the functionality of the component within the final microelectronic device.

A variety of techniques have been developed for the treatment of objects in precision manufacturing processes, particularly for treatment of semiconductor wafers. For example, semiconductor wafers may be dipped in a series of internal chambers of respective treatment vessels that provide separate treatment of the wafers. For example, the wafer may first be imparted with an oxide layer, followed by dipping in an acid bath for etching away some or all of the oxide. The acid bath may then be followed by a rinsing bath. An example of one such treatment vessel is of the type that uses cascade liquid flow processes for batch processing. In a typical cascade liquid flow process, one or more wafers are supported within a cascade processing vessel, such as within a wafer treating fixture, cassette, or other holder, to be treated at the same time. A cascade processing vessel includes an inner vessel having side walls that permit liquid to spill over the top edge and into one or more cascade chambers provided about the inner vessel. A flow of liquid is supplied to the inner vessel, e.g. at the vessel bottom, to fill its internal chamber and to further cause liquid to cascade over the top edge of the internal chamber into an outer chamber. Thus, new liquid (e.g. clean water) can be supplied to rinse the wafers within the internal chamber and then to cascade from the internal chamber into the outer chamber. Liquid flows through the inner vessel during this process.

In the case of processing microelectronic devices, such as including semiconductor wafers at any of various stages of processing, flat panel displays, micro-electrical-mechanical-systems (MEMS), advanced electrical interconnect systems, optical components and devices and components of mass data storage devices (disk drives) and the like, cleanliness is critical in virtually all processing aspects. Representative steps in wet processing of wafers include wafer etching and rinsing. For processing such microelectronic devices, it is important to use clean processing liquids so as not to introduce contaminants into the processing environment, and to using efficient and uniform processing steps.

In this regard, techniques and apparatuses have been developed for treating, rinsing and separating wafers from immersion (or liquid bath) type processes, and, by such process or by a subsequent drying process, to leave wafer surfaces substantially clean. A popular rinsing technique is known as cascade rinsing. Such cascade rinsing utilizes a cascade rinser having inner and outer chambers that are separated from one another by a partition or weir. Rinse water flows from a water source into the inner chamber. The inner chamber fills with rinsing liquid until it overflows so that rinsing liquid cascades over the partition or weir into the outer chamber. Typically, DI water is used as the rinsing liquid, which DI water is preferably rendered extremely clean, such as by filtering as disclosed in U.S. Pat. Nos. 5,542,441, 5,651,379 and 6,312,597 to Mohindra et al.

Typical semiconductor wafer processing tools are designed for conducting treatment processes on a cassette containing a large number of wafers, such as large batches of 25 or 50 wafers, to be treated as a batch process. Treatment of large numbers wafers in a single batch potentially introduces economies of scale. However, extra time may be required to assure adequate treatment of each of the wafers in a batch. Additionally, care must be taken to assure that the batch of wafers does not get damaged in transport. Each wafer increases in value significantly at each process step in the manufacturing process. Thus, if a cassette carrying 25 wafers is dropped, the cost of this accident may be extremely high. Additionally, the footprint and the processing liquid requirements for a tool that is capable of processing a batch of wafers at a time may be quite large. Thus, for the same overall fabrication facility footprint, multiple tools capable of processing only one wafer at a time could potentially approach the throughput of a tool that processes large batches of wafers. The use of single wafer treatment processes as compared to batch processes also has the benefit of distributing the risk of accident. Thus, if something goes wrong in a tool that is handling only one wafer, only one wafer is ruined. In contrast, if something goes wrong in a tool handling a batch of 25 or 50 wafers, a large number of wafers is at risk. Additional improvements are needed, however, to make single wafer processing tools competitive for production of wafers as compared to batch process tools.

### SUMMARY OF THE PRESENT INVENTION

The present invention overcomes the deficiencies and shortcomings of the prior art by providing immersion processing systems for treating wafers that increases the efficiency of chemical use and/or advances the effectiveness of the treatment process. Preferably, the treatment processes of the present invention use less chemicals during the treatment process and are capable of treating wafers rapidly so that, as a function of footprint, to desirable throughput rates may be experienced. Additionally, with the use of single or dual wafer treatment tools, the number of wafers involved in any single equipment error is reduced as compared to large batch process tools.

In one aspect of the present invention, an the immersion vessel is provided that is preferably sized to accommodate a single wafer or two wafers, but with a reduced vessel volume for reducing processing liquid usage, and with the ability to treat one or two wafers effectively. In this aspect, the average distance between the side walls of the immersion vessel and major surfaces of the wafers in the immersion vessel is less than 10 mm. This configuration surprisingly provides the ability to flow processing liquids through the immersion vessel without exposing the surfaces of the wafer to excess turbulence in the processing liquid. This unique fluid dynamic is particularly beneficial, because the wafers are exposed to minimal eddy currents or other variables in exposure of various regions of the wafer to treatment chemicals. Further, this configuration allows for an increase in the velocity of processing liquids as they are introduced or removed from the vessel, without introduction of turbulence. This allows for more rapid turnover time in the addition or removal of any particular chemical treatment solution to the immersion vessel. Additionally, the configuration of the immersion vessel provides a reduced vessel volume as compared to conventional single wafer vessels, thereby reducing the amount of processing liquid that must be used in the treatment process. The reduction of processing liquid that is required in any given treatment process is a substantial benefit because such chemicals may be expensive, and additionally may be difficult to handle or dispose of. The combination of reduced vessel volume, together with the ability to introduce liquid at a higher velocity, substantially reduces the turnaround time and overall treatment time of a wafer in the immersion vessel.

In a particularly preferred aspect of the present invention, two wafers are treated at the same time in the immersion vessel. The inclusion of two wafers, but not more than two wafers, allows for equivalent treatment of the outer surfaces of the wafers (those closest to the walls of the immersion vessel), or alternatively the inner surfaces of the wafers (those closest to the other wafer), because each of these respective surfaces experience nearly identical treatment conditions. Thus, the two wafer immersion vessel configuration has the benefit of using a very small footprint and small amounts of processing liquid, while doubling the throughput of the tool as compared to single wafer tools.

In another aspect of the present invention, at least one of the side walls of the immersion vessel is movable relative to the other side wall, to provide variable volume capacity of liquid in the immersion vessel.

In another aspect of the present invention, immersion vessels comprising a megasonic transducer for enhancing the cleaning of wafers may be provided with side walls angled in such a way that the megasonic energy from the transducer is directed to compensate for damping of the energy as it travels up with the immersion vessel. Thus, a cleaning zone is defined within the immersion vessel as the zone between first and second sidewalls and the proximal and distal boundaries. The proximal boundary is defined as the shortest line from side wall to side wall corresponding to the location of the end of a wafer placed in the vessel for cleaning that is proximal to the transducer. The distal boundary is defined as the shortest line from side wall to side wall corresponding to the location of the end of a wafer placed in the vessel for cleaning that is distal from the transducer. The width of the cleaning zone as measured between the first and second sidewalls is progressively smaller from the proximal boundary to the distal boundary throughout the length of the cleaning zone.

### BRIEF DESCRIPTION OF THE DRAWINGS

FIG. 1a is a cross-sectional side view of a single wafer immersion vessel illustrating a wafer immersed within the liquid bath;

FIG. 1b is a cross-sectional side view of a single wafer immersion vessel illustrating a wafer immersed within the liquid bath;

FIG. 2 is a cross-sectional side view of a single wafer immersion vessel of FIG. 1a;

FIG. 3 is a cross-sectional side view of a dual wafer immersion vessel;

FIG. 4 is a cross-sectional side view of a single wafer immersion vessel with a progressively smaller cleaning zone;

FIG. 5 is a cross-sectional side view of is a dual wafer immersion vessel with a progressively smaller cleaning zone;

FIG. 6 is a cross-sectional side view of a single wafer immersion vessel within nonlinear progressively smaller cleaning zone;

FIG. 7 is a cross-sectional side view of a single wafer immersion vessel having movable sidewalls;

FIG. 8 is a cross-sectional side view of an alternative embodiment of a single wafer immersion vessel having movable sidewalls;

FIGS. 9a-b are cross-sectional side views of a self-cleaning cascade liquid treatment vessel having progressively increasing levels of liquid; and

FIGS. 9c-e are cross-sectional side views of a self-cleaning cascade liquid treatment system having a lid in various stages of closed positions.

### DETAILED DESCRIPTION OF THE PREFERRED EMBODIMENTS

For brevity in the following discussion, the object to be treated will be referred to as semiconductor wafers. It will be appreciated that the process and apparatus as discussed herein benefit the treatment of a wide variety of objects, such as discussed in the Summary of the Invention section above and otherwise throughout this specification.

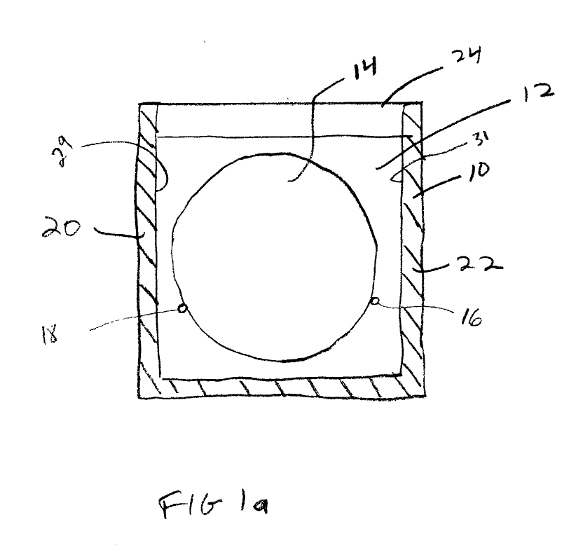

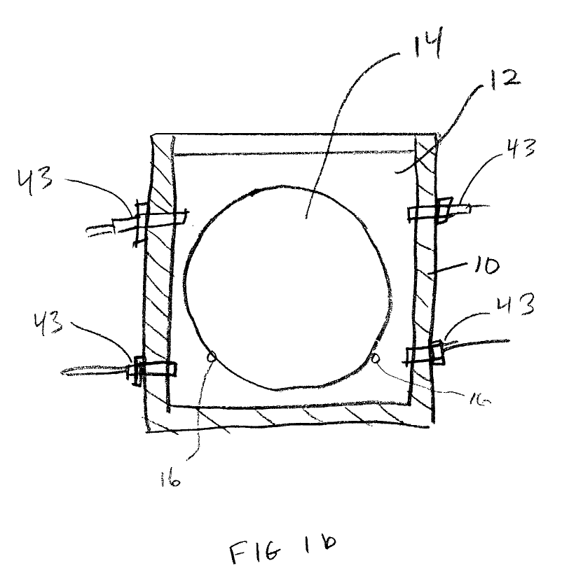

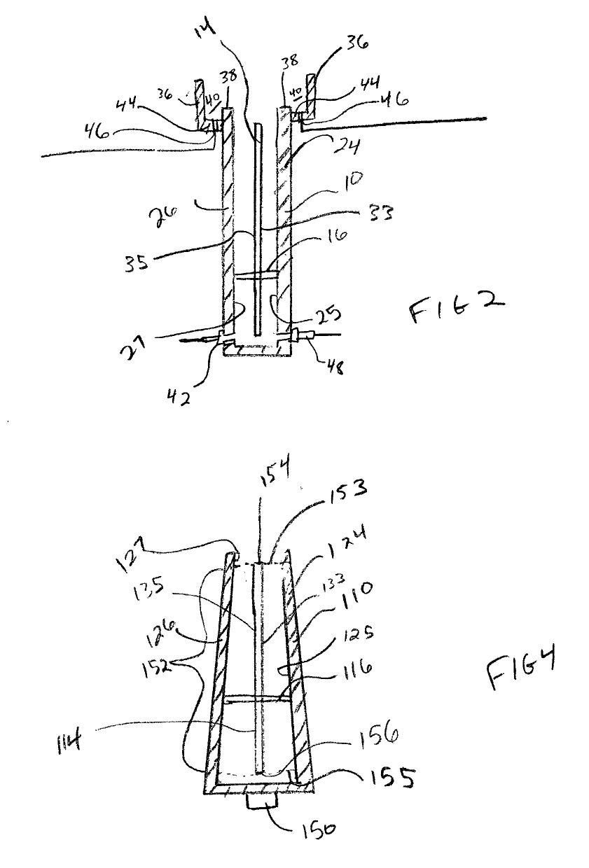

With reference to the accompanying figures, wherein like components are labeled with like numerals throughout, and initially to FIGS. 1a and 2, a single wafer size liquid bath or immersion vessel 10 is illustrated within which a quantity of processing liquid 12 is contained. A wafer 14 is shown immersed entirely within the processing liquid 12 and supported therein by spaced wafer supports 16 and 18. While supports 16 and 18 are schematically illustrated, they are intended to be suitably formed to engage in supporting one or more wafers 14 within immersion vessel 10. Note also that the manner by which wafers 14, are supported within the immersion vessel 10 is not a specific feature of the subject invention, and that any conventional or developed technique (not shown) is contemplated for use in accordance with subject invention. It is preferable, however, that the supporting mechanism not substantially prevent mixing by interfering with the flow of liquids across the surface of the wafer(s). Moreover, the objects may be supported at any different orientation as determined to provide desired results. Alternatively, wafer 14 may be supported by a lift mechanism or elevator system as is described, for example in U.S. patent application Ser. No. (attorney docket No. FSI0094/US) filed on even date herewith.

Immersion vessel 10, as illustrated, is preferably generally rectangularly shaped from above for accommodating a single wafer or for accommodating two wafers as a microelectronic device that may be processed in accordance with the present invention. The microelectronic devices that are processable in accordance with the present invention include semiconductor wafers of all types including those at any stage of processing, flat-panel displays, MEMS devices, electrical interconnect devices and systems, optical components, components of mass storage devices and the like.

The illustrated immersion vessel 10 of FIGS. 1a and 2 is designed, in accordance with one aspect of the present invention, to accommodate single wafer processing illustrated by a single wafer 14. Specifically, the illustrated immersion vessel 10 comprises a pair of spaced end walls 20 and 22 and a pair of spaced sidewalls 24 and 26. The end and sidewalls 20, 22, 24 and 26, respectively, and the materials that make up all components within vessel 10 may comprise any material suitable for a particular processing liquid 12 application, and they may be formed of any number of separate components or as components integral with one another. Particularly preferred materials are selected from ceramic materials such as quartz, sapphire, silicon, silicon carbide and aluminum oxide. Alternatively, component materials may preferably be selected from a fluoropolymer compound selected from the group of fluoropolymers including polytetrafluoroethylene (PTFE), fluorinated ethylene-propylene (FEP), perfluoroalkoxy fluorocarbon resin (PFA), ethylene-chloro trichloroethylene copolymer (ECTFE), ethylene-tetrafluoroethylene copolymer (ETFE), polyvinylidene fluoride (PVDF), combinations of these, and the like.

The end walls 20 and 22 are preferably dimensioned to accommodate the height of processing liquid 12 that is needed in order to cover a wafer 14 suspended or otherwise supported within immersion vessel 10 and to accommodate a wafer diameter and whatever fluid flow requirements are needed to permit sufficient processing liquid 12 presence or flow in immersion vessel 10 between the wafer's diametrically opposed edges and inside surfaces 29 and 31 of end walls 20 and 22, respectively. Such edge flow requirements may be substantially minimal since wafer edge processing is not normally conducted. For other shaped microelectronic devices, it may be desirable to provide a completely differently shaped immersion vessel 10 that may comprise any number of components, the purpose of which is to contain a quantity of processing liquid 12 for treating, rinsing and/or cleaning any portion of or complete microelectronic device. Preferably, the distance between diametrically opposed edges of wafer 14 and inside surfaces 29 and 31 of edge walls 20 and 22, respectively is less than 10 mm, more preferably less than 6 mm and most preferably less than 4 mm.

Likewise, sidewalls 24 and 26 are preferably dimensioned to accommodate the height of processing liquid 12 that is needed in order to cover a wafer 14 suspended or otherwise supported within immersion vessel 10. In one aspect of the present invention, preferably sidewalls 24 and 26 are parallel to each other, and to surfaces 33 and 35 of wafer 14.

Surprisingly, it has been found that substantially reducing the spacing between major surfaces 33 and 35 of wafer 14 and inner surfaces 25 and 27 of sidewalls 24 and 26 as compared to conventional wafer processing systems provides a number of unexpected benefits in the wafer treatment process. Specifically, it has been found that reducing the average distance between the surfaces of the wafer to the sidewalls, more specifically the distance from major surface 33 to inner surface 25 and the distance from major surface 35 to inner surface 27, to an average distance of less than 10 mm, more preferably less than 6 mm, and most preferably less than 4 mm, significantly reduces the amount of turbulence exhibited by the processing liquid 12 as it flows through the immersion vessel 10. Turbulence in processing liquid 12 is undesirable, because it may lead to uneven treatments that are detrimental to the performance of the ultimate final product that is made using the treated wafer. Further, it has been found that significantly reducing the spacing allows for significant increase in the velocity of processing liquid 12 that flows through immersion vessel 10 without resulting in turbulence. This unexpected ability to increase the velocity of processing liquid 12 provides the ability to rapidly exchange or “turn over” the processing liquid 12 in immersion vessel 10. Rapid turnover in turn results in short processing time, improving the throughput of the treatment system.

Further, the small distance between the surfaces of wafer 14 and surface of sidewalls provides a substantial reduction in the amount of processing liquid 12 required for treatment of wafers 14 in the immersion vessel 10. Thus, chemical material savings in terms of volume of use of processing liquids in processing a single wafer may be reduced by 40 percent and up to 60 percent as compared to conventional single wafer processing systems. Particularly preferred systems are designed to accommodate wafers of about 200 mm diameter or greater, and more preferably greater than about 300 mm diameter or greater. Typically, the wafers have a thickness of less than about 1 mm. Preferred sidewall dimensions are less than or equal to about 35 cm by about 35 cm for 300 mm wafers, and about 25 cm×25 cm for 200 mm wafers. A preferred single wafer immersion vessel 10 has a total liquid content volume of less than about 1.2 liters, and more preferably less than about 1 liter of processing liquid 12 for 300 mm wafers, and less than about 700 ml, more preferably less than about 500 ml for 200 mm wafers. A preferred dual wafer immersion vessel has a total liquid content volume of less than about 1.8 liters, and more preferably less than about 1.5 liter of processing liquid for 300 mm wafers, and less than about 1.1 liters, more preferably less than about 750 ml for 200 mm wafers.

Further fluid flow and fluid intake and output features may be provided as necessary or desired for any given treatment process. For example, in the illustrated embodiment of FIGS. 1 and 2, the top edges 38 create a weir structure over which processing liquid can flow. Such top edge surfaces may be flat, as shown, or may be tapered or angled down into cascade chambers 40. One or more notches or other openings may also be provided to assist in fluid flow dynamics and/or distribution along the weir structure.

For supplying processing fluid 12, such as rinsing fluid as part of a cascade rinser as illustrated, a fluid inlet 42 permits fluid communication from a processing liquid source (not shown) into the interior of the immersion vessel 10. Alternatively, fluid inputs may be provided is shown in FIG. 1b. Thus, fluid inputs 43 are preferably located on the sides of immersion vessel 10 to provide less intrusive introduction of processing fluid 12 to immersion vessel 10. In a particular preferred embodiment, at least two fluid inputs 43 are symmetrically positioned on opposite sides of immersion vessel 10. More preferably, at least four fluid inputs 43 are symmetrically positioned on opposite sides of immersion vessel 10, and generally equally spaced from the bottom and from the top of immersion vessel 10. Most preferably, fluid inputs 43 are spaced at the positions about one third of the way up from the bottom of immersion vessel 10, and about two-thirds of the way up from the bottom of immersion vessel 10. As processing fluid 12 is supplied via the fluid inlet 42, and after the immersion vessel 10 is filled with processing liquid 12 up to its sidewall top edges 38, continued processing fluid 12 flow will cause the processing fluid 12 to spill or cascade over the top edges 38 into the cascade chambers 40 provided by outer sidewalls 34. Spacing portions 44 of the outer sidewalls 36 not only help define the width of cascade chambers 40, but also provide space to accommodate cascade chamber fluid drains 46. With separate cascade chambers 40 formed as illustrated, each cascade chamber 40 will preferably include a cascade chamber fluid drain 46, which drains themselves can be provided in any conventional or developed way. The immersion vessel 10 itself is preferably drainable for removing processing liquid 12 at any desired time by way of an immersion vessel drain 48 that may also be further operatively connected with the drain reservoir. Each of the inlet and drains discussed above may be further controlled by any conventional or developed valve mechanisms and/or control systems for controlling fluid flow into and out of the immersion vessel 10 and cascade chambers 40 (or plural portions thereof). If no cascade chamber 40 is provided in any way, processing liquid 12 may simply spill over any edge of the immersion vessel 10.

In the case of an immersion vessel 10 as part of a system where wafers are lifted from and lowered into the immersion vessel 10 (as may be part of any additional system that may include other immersion vessels or other processing stations), a lift mechanism (not shown) may be utilized for separating the wafer 14 from the environment comprising the processing liquid 12, and preferably moving the wafer 14 into an environment comprising gas (which gas environment may also comprise atomized liquids or the like). Such a lift mechanism may comprise any known or developed system suitable for holding the wafer 14 and moving it within and out from the interior volume of the immersion vessel 10, and preferably for moving the wafer 14 between a position above immersion vessel 10 and a position within the vessel 10. Multiple wafer handling devices or systems are also contemplated to distinctly handle one or more wafer moving aspects. Moreover, the wafer 14, or other microelectronic device (that may be differently shaped) may be supported itself within a carrier or cassette (not shown) designed accordingly. Also, it is contemplated that a support structure and/or cassette (not shown) may be provided within the volume of the immersion vessel 10 for supporting wafer 14 as it may be positioned, for example, by a lift mechanism (not shown).

Any known or developed wafer holding and lifting and lowering mechanism is contemplated to be used in accordance with the present invention. It is preferable, however, that edge holding be utilized to minimize contact with the first and second major surfaces 33 and 35 of wafer 14 and to facilitate better processing, rinsing and cleaning of such wafer surfaces. Suitable edge holding type lift mechanisms are also described, for example, in co-pending U.S. Provisional Patent Application Serial No. 60/338,044, filed Nov. 13, 2001, which is commonly owned by the assignee of the subject application and the disclosure of which is fully incorporated herein by reference.

Alternatively, for changing the environment comprising the processing liquid 12 to an environment comprising gas (i.e. for separating the wafer from its processing liquid bath), the processing liquid 12 may be drained from the immersion vessel 10, such as via drain 48. Wafer 14 may be supported from above, as schematically illustrated, or may be supported by a cassette or other support device (not shown) provided within the immersion vessel 10. During processing liquid 12 drainage, the cascading effect (if provided for) would cease, unlike a lifting type separation where the cascading effect (if provided for) could continue. It is also contemplated that wafer separation could be conducted by any combination of lifting and draining processing liquid 12.

In accordance with processes of the present invention, the processing liquid 12 may comprise any processing liquid to which exposure to at least a portion of a wafer surface is desired and which processing liquid is to be delivered to such wafer surface as an immersion or liquid bath type process. That is, for semiconductor wafer processing as an example, the processing liquid 12 may comprise an active processing fluid such as an etchant, which could be an HF solution, a buffered HF solution, an HCl solution, or the like, and that may be the controllably caused to flow over surfaces of wafer 14.

For rinsing a wafer 14, as another example, such as may be conducted after any processing step like an HF etching step, rinsing liquid may be supplied to the immersion vessel 10 after a first processing liquid is drained, or, in the case with a cascade processing vessel, the rinsing liquid may be supplied subsequently in order to controllably displace the processing liquid flowing past the wafer surfaces. For rinsing, DI water is preferred as the processing liquid 12 for cleaning or rinsing wafer 14 surfaces and removing any left over processing liquids from any previous processing step. More preferably, ultra-purified DI water is supplied for such a rinsing process, such as may be obtained by a filtering system described in commonly owed U.S. Pat. Nos. 5,542,441, 5,651,379 and 6,312,597 to Mohindra et al., the entire disclosures of which are incorporated herein by reference.

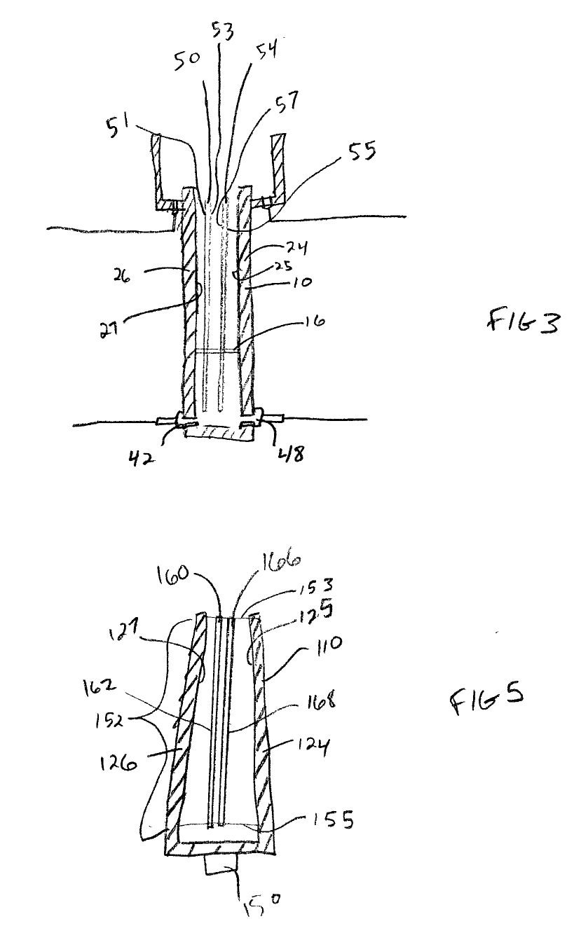

FIG. 3 shows immersion vessel 10 holding two wafers 50 and 54. First wafer 50 has a first major surface 51 and a second major surface 53, and second wafer 54 likewise has a first major surface 55 and a second major surface 57. As shown, wafers 50 and 54 are oriented with their respective second major surfaces 53 and 57 toward each other, and first major surfaces 51 and 55 oriented facing outward toward the inner surfaces 25 and 27 of walls 24 and 26. In a preferred embodiment, first major surfaces 51 and 55 are surfaces that are particularly designated to be treated for use as the operational surfaces or the “device sides” of the wafers. Alternatively, wafers 50 and 54 could be oriented with their second major surfaces 53 and 57 oriented facing outward toward the inner surfaces 25 and 27 of walls 24 and 26, and with first major surfaces 51 and 55 oriented toward each other. Optionally, though less preferably, wafers 50 and 54 could be oriented with second major surface 53 of wafer 50 oriented toward first major surface 55 of wafer 54. This alternative arrangement is less preferred because it is less likely that the first major surfaces 51 and 55 will receive experience identical treatment conditions due to their different relative environment in immersion vessel 10. Preferably, wafers 50 and 54 are spaced less than 10 millimeters apart, and more preferably are between 4-6 mm apart. The spacing is particularly preferred when wafers 50 and 54 are oriented so that first major surfaces 51 and 55 (when such surfaces have been designated as the “device side” surfaces) are directed toward each other.

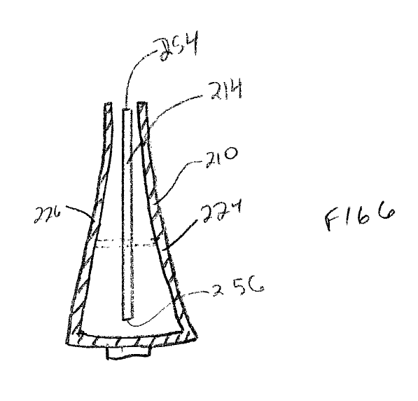

Another aspect of the present invention provides a system for megasonically cleaning a single wafer wherein the width between the first and second sidewalls generally decreases with increasing distance from the transducer at a rate effective to provide substantially equivalent intensity of megasonic energy at any surface point throughout the length of a wafer placed within the vessel. An embodiment of this invention is illustrated in FIG. 4, which is a cross-sectional side view of a single wafer immersion vessel 110 within which a quantity of processing liquid (not shown) is contained. A wafer 114 is shown supported therein by spaced wafer support 116. Optional features of the immersion vessel related to wafer support, fluid introduction and removal, and the like are as described in the embodiment shown in FIGS. 1 and 2 above. Additionally, the embodiment as shown in FIG. 4 comprises a megasonic transducer 150 that is capable of imparting megasonic energy to the surfaces 133 and 135 of semiconductor wafer 114. Megasonic energy cleaning apparatuses have been advantageously employed to clean contaminants from semiconductor surfaces, such as disclosed in U.S. Pat. No. 4,869,278 to Bran. Megasonic energy cleaning apparatuses comprise a piezo-electric transducer adhered to a transmitter. The transducer is electrically excited such that it vibrates. In combination with the transmitter, high frequency energy is emitted into a vessel containing liquid, thereby imparting megasonic energy to the surfaces of semiconductor wafers in the vessel. Contaminants are thus vibrated away from the surfaces of the wafer. When the wafer is removed, the surfaces are cleaner than if the wafer was merely inserted into a stationary bath of processing fluid.

Because the transducer 150 is located at the bottom of immersion vessel 110, the megasonic energy emitted therefrom is directed in a primarily vertical direction. In a conventional vessel, there is inevitably damping of the megasonic energy as the sound travels through the processing liquid. In conventional vessels, therefore, the sound will have a higher intensity near the source than at the distal end of a wafer. This damping effect surprisingly has been found to be particularly pronounced in immersion vessels having a small average distance between the side walls of the vessel and the major surfaces of the wafer. The embodiment of immersion vessel 110 as shown in FIG. 4 contains cleaning zone 152, which is defined as the region of immersion vessel 110 between the inner surfaces 127 and 125 of side walls 126 and 124, respectively and between distal boundary 153 (corresponding to the shortest line between sidewalls 126 and 124 at distal end 154 of wafer 114) and proximal boundary 155 (corresponding to the shortest line between side walls 126 and 24 at proximal end 156 of wafer 114). The width of cleaning zone 152 as measured between the inner surfaces 127 and 125 of side walls 126 and 124 is progressively smaller from proximal boundary 155 to distal boundary 153.

The narrowing of the cleaning zone 152 surprisingly compensates for the loss of intensity in the megasonic energy as the energy travels up the vessel. While not being bound by theory, it is believed that the angle of the sidewalls relative to the wafer reflects and focuses the megasonic energy such that the effective energy imparted to the surface of the wafer is essentially the same throughout the length of the wafer, thereby compensating for the damping effect caused by the side wall material and the processing liquid in narrow space between the wafer and the side wall.

The required degree of narrowing of the cleaning zone 152 is in part determined by the acoustic characteristics of the chamber walls 124 and 126. Thus, walls made from sound absorbing material, such as plastic, will tend to dissipate the megasonic energy, thereby requiring a larger taper in the wall. Walls made from acoustically reflective (or “hard”) material, such as ceramic, silicon, quartz, SiC and aluminum oxide, do not require as great a degree of narrowing as acoustically absorbing material. The preferred immersion vessel 110 of the present invention comprises walls 124 and 126 spaced such that the distance between the inner surface 125 and 127 at proximal border 155 is about 6-12 mm (more preferably about 6-9 mm), and the distance between the inner surfaces at distal border 153 is about 3-9 mm (more preferably about 4-9 mm) and is narrower than the distance at the proximal border. Thus, the difference between inner surface 125 and major surface 133 of the wafer is preferably about 3-6 mm at proximal border 155, and is preferably about 1.5-4.5 mm at distal border 153. Likewise, the difference between inner surface 127 and major surface 135 of the wafer is preferably about 3-6 mm and proximal border 155, and is preferably about 1.5-4.5 mm at distal border 153. The present aspect of this invention provides as an additional benefit the ability to select alternative materials for use as walls of immersion vessel 110 where megasonic energy is additionally used in the process, because materials having high dissipation of megasonic energy that were not thought appropriate for use with megasonic energy may now be used by adapting the relative configuration of the walls 124 and 126 of immersion vessel 110.

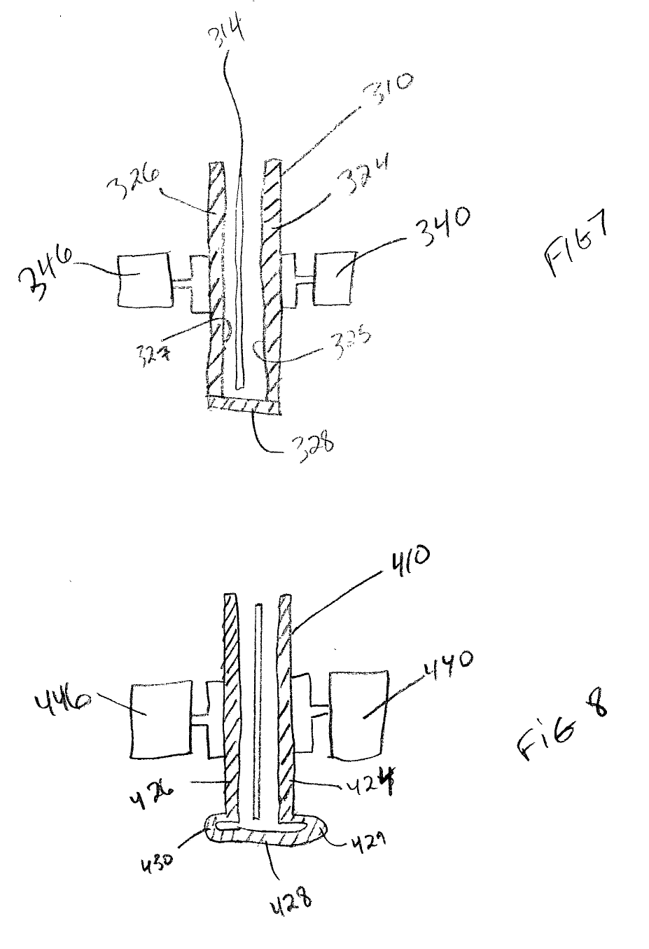

FIG. 5 is a cross-sectional view of a preferred embodiment of the present invention, wherein two wafers are provided in immersion vessel 110 as described above in FIG. 4. The megasonic energy that is imparted to wafers 160 and 166, particularly at outer surfaces 162 and 168, are modified by the angle of inner surfaces 125 and 127. Preferably, the difference between inner surface 125 and major surface 168 of the wafer is preferably about 3-6 mm and proximal border 155, and is preferably about 1.5-4.5 mm at distal border 153. Likewise, the difference between inner surface 127 and major surface 162 of the wafer is preferably about 3-6 mm at proximal border 155, and is preferably about 1.5-4.5 mm at distal border 153. Preferably the distance between wafer 160 and wafer 166 is less than 10 mm apart, and more preferably between about 4-6 mm apart.

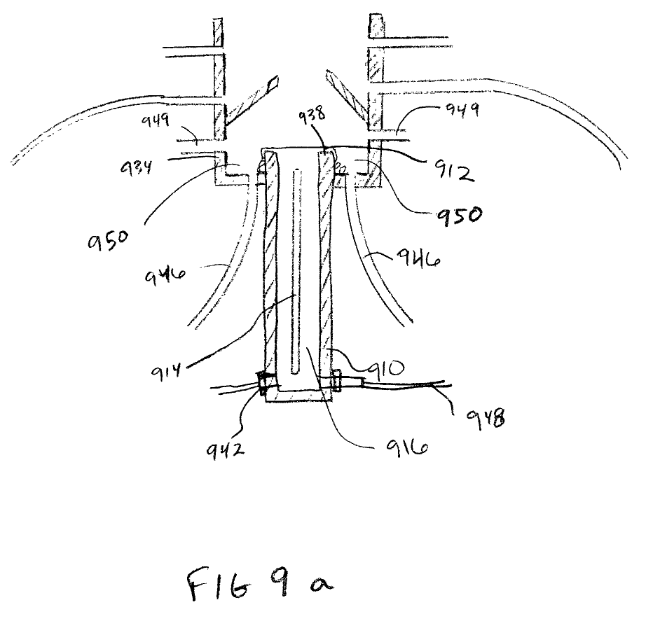

FIG. 6 is a cross-sectional view of an alternative embodiment of immersion vessel 210, comprising non-linear walls and 224 and 226, having a curved surface rather than a flat surface. The curved shape of walls 24 and 226 provide an alternative degree of compensation for dissipation of megasonic energy from proximal end 256 to distal end 254 of wafer 214. Immersion vessel 210 may optionally be adapted to accommodate two wafers for treatment therein.

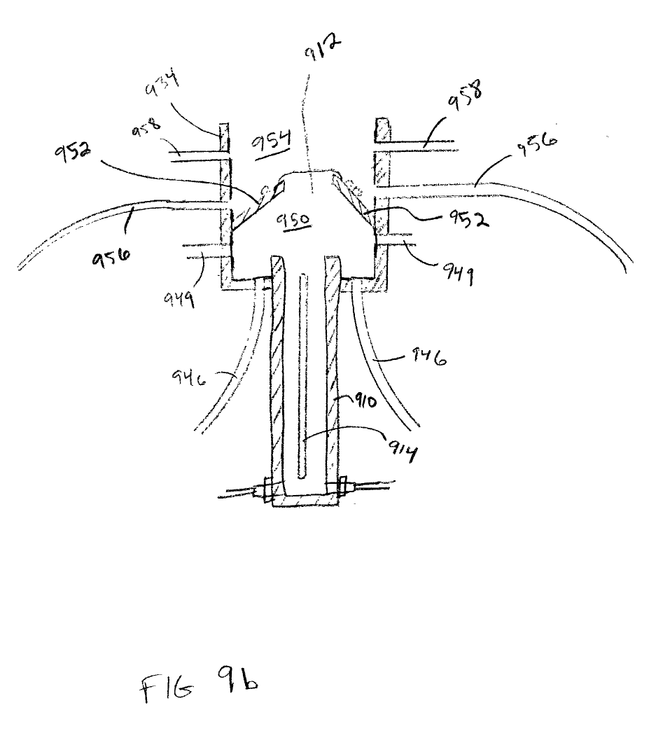

FIG. 7 is a cross-sectional view of yet another alternative embodiment of immersion vessel 310, wherein the space between walls 324 and 326, and more specifically inner surface 325 and 327 or may be modified or adjusted either before or after placement of wafer 314 therein. Thus, side walls 324 and 326 may optionally be slidably engaged with bottom 328, so that biasing members 340 and 346 may impart an inwardly moving force to walls 324 and 326, thereby narrowing the distance between inner surface 327 and 325. Biasing members 340 and 346 may be any appropriate device for imparting inward force to the walls. For example, biasing member may be a piston, bladder, electromagnet, screw drive or the like.

As shown, two biasing members are utilized to move the walls of immersion vessel 310. Alternatively, only one biasing member need be used to move one of the side walls, with the other side wall being stationary.

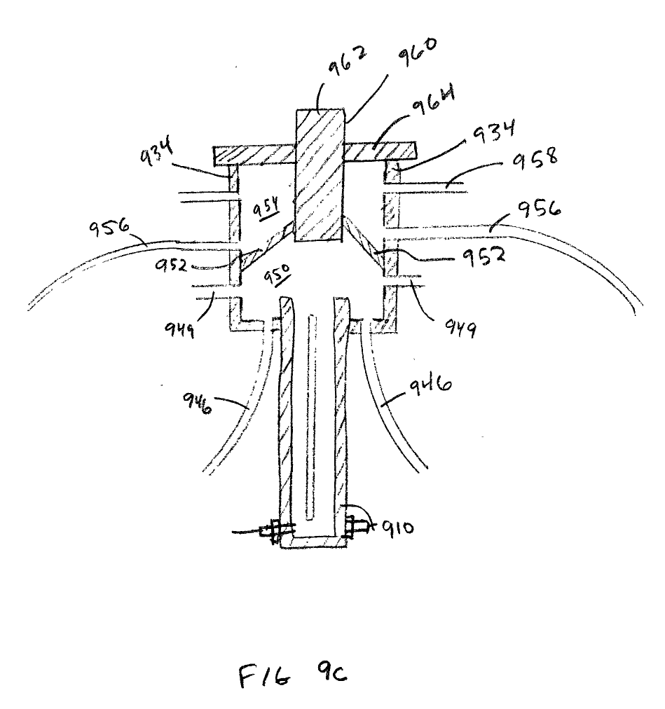

FIG. 8 is a cross-section of an alternative embodiment of immersion vessel 410, wherein bottom 428 is integrally connected with side walls 424 and 426. In this embodiment, when biasing members 440 and 446 impart an inwardly directed force to side walls 424 and 426, side connective portions 429 and 430 flex, providing an integrally connected continuous immersion vessel 410 with no friction interface between side walls 424 and 426 and bottom 428. This embodiment is generally preferred, because frictional interfaces between working members tend to introduce particles into the immersion bath that may deleteriously affect the purity of the treatment liquids. Immersion vessel embodiments having movable side walls are particularly advantageous where very small gaps between side walls and the wafers to be treated in the immersion vessels are desired. In a preferred embodiment, the side walls 424 and 426 of immersion vessel sufficiently spaced to provide easy access ingress and egress of wafers from immersion vessels. Once the wafer is in place in the immersion vessel, the gap between side walls may be deceased by biasing the side walls 424 and 426 toward each other as desired to provide an appropriately narrowed gap. Thus, not only can the distance from the wafer to the side wall be narrowed to provide for less turbulence as treatment fluid is flowed through the immersion vessel, but the overall volume of the immersion vessel at the relevant portion of the vessel (i.e., the location where treatment fluid will be located) may be reduced. Optionally, the angle of walls 324 and 326 may be modified as well to provide a progressively smaller distance between the side walls in the cleaning zone as discussed above. In either embodiment as illustrated, after treatment of the wafer in the immersion vessel, the wall may be conveniently moved outward again to provide more space for removal of the wafer from the immersion vessel.

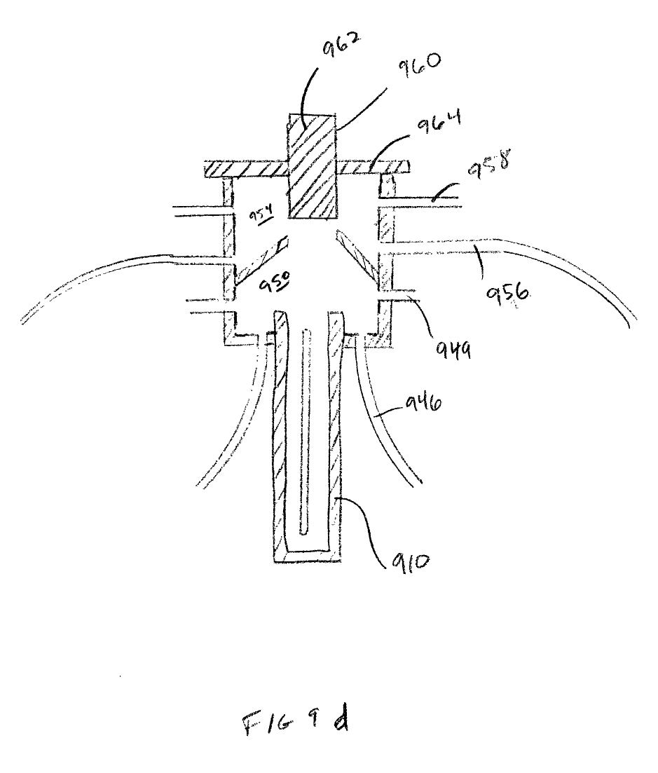

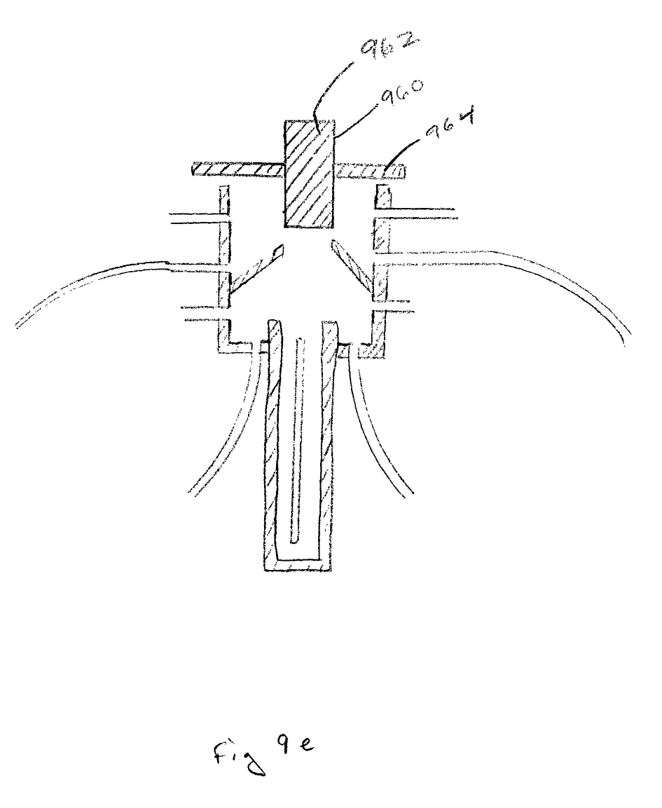

In another aspect of the present invention, immersion vessels may be provided with a self-cleaning cascade chamber assembly, such as shown in FIGS. 9a, 9b and 9c. Turning first to FIG. 9a, immersion vessel 910 is provided with a processing liquid 912 for treatment of wafer 914. During the treatment or after treatment has been accomplished, processing liquid 912, which is supplied by processing liquid inlet 942, is allowed to overflow treatment chamber 916 causing the processing fluid 912 to spill or cascade over the top edges 938 into secondary cascade chamber 950 provided by outer side walls 934. Processing liquid 912 flows out of secondary cascade chamber 950 through primary drains 946. Excess air that may exist in the headspace above immersion vessel 910 is exhausted through primary exhausts 949. Immersion vessel 910 may optionally be drainable by immersion vessel drain 948.

Turning now to FIG. 9b, cleaning of the secondary cascade chamber 950 after processing may be accomplished by closing primary drains 946 and primary exhausts 949, while supplying additional processing liquid 912 into immersion vessel 910. Preferably, wafer 914 is not present during the cleaning process. Processing liquid 912 is then allowed to overflow secondary cascade chamber 950, causing the processing fluid 912 to spill or cascade over tertiary cascade chamber walls 952 into tertiary cascade chamber 954 formed by tertiary cascade chamber walls 952 and side walls 934. Processing liquid 912 flows out of tertiary cascade chamber 954 through secondary drains 956 and excess air flows out of secondary exhausts 958. This additional flow from secondary cascade chamber 950 to tertiary cascade chamber 954 cleans all the surfaces surrounding the secondary cascade chamber 950 and most of the surfaces in tertiary cascade chamber 954.

Each of the inlet and drains discussed above may further be controlled by any conventional or developed valve mechanisms and or control systems for controlling fluid flow into and out of immersion vessel 910, secondary cascade chamber 950 and tertiary cascade chamber 950.

FIG. 9c is a cross-sectional view of a self cleaning cascade chamber assembly as shown in FIGS. 9a and 9b, and further comprising lid 960 positioned over secondary cascade chamber 950 optionally contacting tertiary cascade chamber walls 952, and positioned over tertiary cascade chamber 954, optionally contacting outer side walls 934. Alternatively, lid 960 is in close proximity to chamber walls 952 without contacting. In this embodiment, a vacuum may be drawn in chamber 950 to contain gasses and chemistries therein. Lid 960 comprises secondary cascade chamber lid 962 and tertiary cascade chamber lid 964, which are preferably separately operable for closing secondary cascade chamber 950 and tertiary cascade chamber 954, respectively. When lid 960 is in position, all gases and chemistries being used in the immersion vessel 910 are contained therein, optionally being drained or exhausted using primary exhausts 949 and primary drains 946. As shown in FIG. 9d, secondary cascade chamber lid 962 is withdrawn, thereby opening secondary cascade chamber 950 and allowing processing liquids to overflow into tertiary cascade chamber 954. Tertiary cascade chamber 954 remains closed, with optional draining or exhausting of gasses or liquids using secondary exhausts 958 and secondary drains 956. Because tertiary cascade chamber lid 964 remains in place in optional contact with tertiary cascade chamber walls 952, all gases and chemistries remain contained in processing vessel 910. As shown in FIG. 9e, lid 960 is completely withdrawn, including both secondary cascade chamber lid 962 and tertiary cascade chamber lid 964. The ability to remove lid 960 provides access to immersion vessel 910 for removal or insertion of wafers, or to carry out various maintenance tasks as required.

All patents, patent documents, and publications cited herein are incorporated by reference as if individually incorporated. Unless otherwise indicated, all parts and percentages are by weight. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A single wafer liquid treatment system, said system comprising:
an immersion vessel comprising at least first and second sidewalls opposite each other for receiving a generally planar wafer having first and second major surfaces during liquid treatment, wherein when a wafer is in the vessel, the average distance between said sidewalls and said major surfaces of the wafer is less than 10 mm.

2. The system of claim 1, wherein the average distance between said sidewalls and said major surfaces of the wafer is less than 6 mm.

3. The system of claim 1, wherein the average distance between said sidewalls and said major surfaces of the wafer is less than 4 mm.

4. The system of claim 1, wherein the vessel is of sufficient size to accommodate a generally planar wafer having a major surface diameter of 300 mm.

5. The system of claim 1, wherein the vessel has a treatment liquid capacity of less than about 1.2 liters.

6. The system of claim 1, wherein the first and second sidewalls are parallel to each other.

7. A single wafer liquid treatment system, said system comprising:
a) an immersion vessel comprising at least first and second sidewalls opposite each other, said vessel comprising a wafer supports for receiving a generally planar wafer;
b) a wafer having first and second major surfaces;
wherein the wafer is supported in the vessel so that the average distance between the first sidewall and the first major surface of the wafer is less than 10 mm, and the average distance between the second sidewall and the second major surface of the wafer is less than 10 mm.

8. A dual wafer liquid treatment system, said system comprising:
an immersion vessel comprising at least first and second sidewalls opposite each other for receiving two generally planar wafers during liquid treatment, each wafer having first and second major surfaces, wherein when two wafers are in the vessel, the average distance between each of said sidewalls and at least one of the major surfaces of at least one of the wafers is less than 10 mm.

9. The system of claim 8, wherein the average distance between each of said sidewalls and at least one of the major surfaces of at least one of the wafers is less than 6 mm.

10. The system of claim 8, wherein the average distance between each of said sidewalls and at least one of the major surfaces of at least one of the wafers is less than 4 mm.

11. The system of claim 8, wherein the vessel is of sufficient size to accommodate two generally planar wafers, each having a major surface diameter of 300 mm.

12. The system of claim 8, wherein the vessel has a treatment liquid capacity of less than about 1.5 liters.

13. The system of claim 8, wherein the first and second sidewalls are parallel to each other.

14. A dual wafer liquid treatment system, said system comprising:
a) an immersion vessel comprising at least first and second sidewalls opposite each other;
b) a first generally planar wafer having first and second major surfaces;
c) a second generally planar wafer having first and second major surfaces;
wherein the first wafer is supported in the vessel so that the average distance between the first sidewall and the first major surface of the first wafer is less than 10 mm, and wherein
the second wafer is supported in the vessel so that the average distance between the second sidewall and the first major surface of the second wafer is less than 10 mm.

15. The system of claim 14, wherein the average distance between the second major surface of the first wafer and the second major surface of the second wafer is less than 10 mm.

16. A system for megasonically cleaning a wafer with a cleaning liquid, comprising:
an immersion vessel comprising at least first and second sidewalls opposite each other for receiving a generally planar wafer having first and second major surfaces during liquid treatment;
a megasonic transducer associated with said vessel in a manner effective to project megasonic energy into said liquid within said vessel; and
a cleaning zone defined as the zone between said first and second sidewalls and a proximal boundary corresponding to the location of an end of a wafer placed in said vessel for cleaning that is proximal to said transducer, and a distal boundary corresponding to an end of a wafer placed in said vessel for cleaning that is distal from said transducer;
wherein the width of the cleaning zone as measured between the first and second sidewalls is progressively smaller from the proximal boundary to the distal boundary throughout the length of the cleaning zone.

17. The vessel of claim 16, wherein the width of the cleaning zone is linearly progressively smaller from the proximal boundary to the distal boundary throughout the length of the cleaning zone.

18. The vessel of claim 16, wherein the width of the cleaning zone is non-linearly progressively smaller from the proximal boundary to the distal boundary throughout the length of the cleaning zone.

19. The vessel of claim 16, wherein the first and second sidewalls are made from an acoustically reflective material.

20. The vessel of claim 19, wherein the first and second sidewalls are made from a material selected from the group consisting of quartz, sapphire, silicon, silicon carbide and aluminum oxide.

21. The vessel of claim 16, wherein the width of the cleaning zone at the proximal boundary is 6-12 mm, and the width of the cleaning zone at the distal boundary is about 3-9 mm and is narrower than the distance at the proximal border.

22. The vessel of claim 16, wherein the width of the cleaning zone at the proximal boundary is about 6-9 mm, and the width of the cleaning zone at the distal boundary is about 4-9 mm and is narrower than the distance at the proximal border.

23. A system for megasonically cleaning wafers with a cleaning liquid, comprising:
a vessel in which one or two wafers may be placed during cleaning, said vessel comprising at least first and second sidewalls opposite each other;
a megasonic transducer associated with said vessel in a manner effective to project megasonic energy into said liquid within said vessel;
wherein the width between the first and second sidewalls generally decreases with increasing distance from the transducer at a rate effective to provide substantially equivalent intensity of megasonic energy at any surface point throughout the length of a wafer placed within the vessel.

24. A wafer liquid treatment system, said system comprising:
an immersion vessel comprising at least first and second sidewalls opposite each other for receiving at least one generally planar wafer, wherein at least one of said first and second sidewalls is movable relative to the other to provide variable volume capacity of liquid in said vessel.

25. The system of claim 24, wherein at least a portion of one of said first and second sidewalls is flexible.

26. A self-cleaning wafer liquid treatment system, comprising
a) a primary chamber comprising a fluid input and a closable drain valve;
b) a secondary cascade chamber in fluid communication with the primary chamber, said secondary cascade chamber comprising a closable drain valve; and
c) a tertiary cascade chamber in fluid communication with the secondary cascade chamber;
wherein upon closing of the primary chamber drain valve with continued introduction of fluid, fluid from said primary chamber overflows into said secondary cascade chamber, and wherein upon closing of the primary chamber drain valve and the secondary cascade chamber drain valve with continued introduction of fluid, fluid from said secondary cascade chamber flows into said tertiary cascade chamber, thereby exposing fluid to all surfaces of said secondary cascade chamber.

27. The self-cleaning system of claim 26, said system further comprising a lid reversibly enclosing said secondary cascade chamber and a lid reversibly enclosing said tertiary cascade chamber.
